(19) United States
(12) Patent Application Publication
(10) Pub. No.: US 2008/0217575 A1
(43) Pub. Date: Sep. 11, 2008

(54) Coating formulation for magnetic imaging in a wet film

(76) Inventor: Bruce Kenneth Bachman, Bonita, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/074,677

(22) Filed: Mar. 4, 2008

Related U.S. Application Data
(60) Provisional application No. 60/905,346, filed on Mar. 6, 2007.
(60) Provisional application No. 60/905,383, filed on Mar. 6, 2007.

(51) Int. Cl. H01F 1/33

(52) U.S. Cl. 252/62.54

(57) ABSTRACT

A paint for application in a layer on a substrate and adapted to form images in said layer using a magnetic field communicated therethrough. The paint includes a mixture of a substantially clear resinous carrier having magnetically orientable particles added. A first additive is included to maintain an orientation of the particles induced by magnetic field through the wet-film of the clear resinous carrier applied to a substrate to maintain said particles in their orientation until the wet-film dries. A second additive may be included to prevent settling of the particles and allow application of the wet-film on a vertical substrate. A third additive may also be included to maintain the wet-film in a wet state for a sufficient time to orient the particles with a magnetic field.

### FIELD OF THE INVENTION

This application claims priority from U.S. Provisional Patent Application Ser. No. 60/905,346 filed Mar. 6, 2007, and U.S. Provisional Patent Application Ser. No. 60/905,383 filed Mar. 6, 2007, both of which are incorporated herein in their entirety by reference. The disclosed invention relates to paint or coatings used for spay painting, silk screening, or other processes where a paint is adhered to a surface of substrate. More particularly it relates to a formulation for such a paint or coating used in such processes, which imparts a layer to the surface of the substrate which upon drying, appears to a viewing person, to have three-dimensional spatial-like images. Employing the disclosed formulations to the paint having magnetically influenced particle or pigment compositions, the improvement overcomes conventional limitations of both lack of detail and clarity as well as concurrently enabling new modes of imparting the field to the wet-film layer with an increase in the rate of production of such images applied to the surface of the substrates.

### BACKGROUND OF THE INVENTION

Enclosures, housings, covers, planar surfaces or even stand-alone single pieces from a set, are frequently coated with paint for protective purposes and especially for decorative purposes. Paint as employed herein, means any liquid, liquefiable, or mastic composition, which after application to a substrate or surface in a thin layer, cures or dries to an opaque substantially solid film.

In modern society, products such as enclosures, housings covers, planar surfaces and products are frequently designed and manufactured from ferrous or non-ferrous materials such as aluminum, magnesium, copper, brass, zinc castings, or of injection molded plastics or magnesium; graphite composites or epoxies, thermoformed plastic sheeting, molded urethanes, in-molded decorated films or polymer sheets and a plethora of other types of materials. In an important step for both marketing and product manufacturing of such products that exterior surfaces are often filmed or coated for either functional or cosmetic and decorative purposes.

For decorative purposes, coatings having magnetic pigments have in recent times been employed in paint and coatings for some products to render indicia and cured three-dimensional figures to the product surfaces using magnetic fields to arrange and align the magnetically influenced pigments into an image, letter, logo, pattern, symbol or other design type of indicia.

The current methods for achieving these induction influenced images generally comprise applying a layer of paint having a carrier and magnetically influenced pigments in liquid form onto a surface or substrate. Such conventional paint or film usually contains magnetically influenced particles or flakes which will react and reorient in proximity to a magnetic field. Once the liquid coating is applied by spraying, silkscreening, or other conventional means of application to the surface, a magnetic field is imparted onto selected regions of the applied paint or film while the coating is in a wet-film state. The field alters and imparts an orientation to the magnetically influenced particles or flakes in the wet-film. Once so oriented, the coating cures or dries to a solid film state thereby fixing the reoriented particles or flakes into angled and other non-parallel orientations upon the substrate being coated thereby rendering an image having a spatial effect upon the substrate it covers. It is important in the current mode of such coating, to leave the wet-film coating adjacent to the source of the magnetic field, for a duration long enough for the wet-film coating co-solvents to sufficiently flash off to render the wet-film to a state that maintains the particles in their orientations for the image or indicia to be properly rendered to the surface. If the wet-film of applied paint is too liquid, the wet-film can flow, or the magnetically positionable particles may move both of which distort the image, even though the image itself is fixed.

Conventional paints and coatings employed for this purpose have a shortcoming in that the drying of the wet-film having the magnetically induced images is a relatively slow process. This is primarily because the wet-film of currently manufactured paint sprayed or applied to a substrate must be maintained in place within the magnetic field for a long duration while the wet-film dries or the imparted image will diffuse, blur or may entirely disappear if moved too soon.

Further, most currently employed magnetically induced image processes communicate the magnetic field through the wet-film from below the substrate surface being coated. This positioning further impairs the speed of the process and limits the type and viewing angles of the images imparted to the wet-film and consequently viewable in the finished renderings on the surface of the substrate. Such conventional and prior methods communicating the magnetic field from below the substrate and wet-film, also require that both sides of the substrate must have planar or flat surfaces and the substrate must have a limited internal thickness, thus dramatically limiting shapes of substrate where the coating may be applied.

In the conventional method dictated by currently available paint lacking means to maintain particle orientation in the wet-film, the part having the substrate for coating is placed directly upon an actual magnet and the substrate is then spray coated. The magnet(s) communicates the magnetic field through the substrate and imparts the inducted image. Both top and bottom sides of the substrate need to be relatively parallel to enable the induced field to be uniform, and for the image to maintain crispness of definition and detailing. However, the inherent properties of molded plastics and their structure benefits usually dictate a non-linear exterior surface (depth of edges, portals, contours, curvatures) as well as interior supporting ribs, bosses, secondary mechanical features which are well known of the trade, thus making a uniform, flat top side or underside surface only applicable as a molded, extruded or cast sheet. This limits the employment of conventional paint to substantially planar parts.

If the magnet is not immediately adjacent to the substrate and is instead further distanced away from wet-film substrate being coated, the resultant magnetic field is either weak or nearly nonexistent preventing a proper image formation. It is the experience of the inventor that using conventional paint and tooling, a distance between a magnet and the wet filmed substrate surface of less than 0.040″ or 1.0 mm needs to be uniformly maintained to allow any degree of image definition or clarity. Using such conventional paint, once the distance exceeds 0.080″ or 2.0 mm, the image is completely diffused and at perhaps 0.160″ or 4.0 mm the image becomes entirely diffused.

Various additives are conventionally added to such paint and film coatings to maintain the magnetically influenced particles in place in the wet-film. However, most such additives degrade the image clarity since they tend to be opaque in nature. Such currently employed additives yielding inferior results include for instance, thixotropes such as polysaccharides, magnesium aluminum silicate, talc (magnesium sulfate), titanium dioxide, conventional inorganic colorants, pigment extenders such as barium sulfate, calcium carbonate aluminum silicate, feldspar, mica, silica, barium sulfate (green colorant) iron oxide, zinc oxide and zinc sulfate, antimony oxide and aluminum phosphate( white).

So by placing such additives to control particle orientation, conventional coatings derogate the image through their opaque nature. However, there is a balance which must be maintained to allow particle movement and reorientation and preventing it. The coating should also be rendered with sufficient wetness to allow the particles to move and reorientate during the impartation of the magnetic field.

Accordingly, there is an unmet need for a paint or film coating material which will carry magnetically influenced particles or pigments while wet and allow images to be imparted to the wet-film coating the substrate by a magnetic field. Such a paint or coating material should allow the substrate surface being coated to be moved or relocated once the image is magnetically imparted, but while the coating is still in a wet film state. Such a paint should concurrently maintain the angles and positions of the magnetically attractive particles or pigments in the wet-film while it is removed from the field and dries. Such a paint or coating should also have sufficient wetness imparted to allow time for the particles to reorientate in the induced field before the wet-film dries, but not so wet as to disorient the image or diffuse it. Such a coating or paint would thus allow for fast and easy impartation of the image with the magnetic field acting on influenced particles or pigments, and a relatively immediate movement thereafter to allow another wet-film coated substrate to come under magnetic influence. Such a coating should allow for substrates to be coated which are non-planar and of varying thickness. Further, such a coating material should maintain transparency of the wet-film and dried coating to prevent image degradation.

It is thus an object of the invention to provide a formulation for paint or coatings carrying magnetically positionable particles or pigments, using additives which provide a means to maintain the reorientation of the particles imparted by a magnetic field once that field is removed and until the wet film coating has dried.

It is a further object of this invention to provide such a formulation that will allow the coating to be applied to a substrate, wherein the magnetic field may be communicated from either above or below the substrate and wet-film coating.

It is a further object of this invention to provide such a paint or coating of a formulation which resists sedimentation of the magnetically positionable particles during drying.

Yet another object of the invention is the provision of a paint or coating of a formulation which maintains the field generated orientation of the particles therein, yet also dries with sufficient transparency not to degrade the imparted image.

Yet another object of this invention is the provision of such a coating which has sufficient initial wetness to allow time for the particles to reorientate in the magnetic field.

These together with other objects and advantages which will become subsequently apparent reside in the details of the formulation and method as more fully hereinafter described and claimed, reference being had to the accompanying drawings forming a part thereof, wherein like numerals refer to like parts throughout

### BRIEF DESCRIPTION OF DRAWINGS

FIG. 1 is a simplified cross section of substrate with coated clear or transparent colored resin film containing additive of conventional metallic or mica flake, with optional clear top coat film.

FIG. 2 is a simplified cross section of a substrate with coated clear or transparent colored resin film with additives of iron or other oriented spheres, particles or flakes which are positionable for reorientation using an electrical charged forces of induction (magnetic) and optional clear top coat film.

FIG. 3 is a simplified cross section of substrate with coated clear or transparent colored resin film containing additive of iron or other oriented spheres, particles or flakes subject to reposition by electrical charged forces of induction (magnetic) with an additive of the invention included to maintain the orientation of the particles or flakes within the wet-film and showing optional clear top coat film.

FIG. 4 is a simplified cross section of substrate with coated clear or transparent colored resin film containing particles of iron or other magnetically positionable spheres, particles or flakes with the specialty additive of the invention included to orientate said spheres, particles or flakes within the wet-film and enabling reorientation of said spheres, particles or flakes under electrically charged forces of induction from overhead the wet film coating upon the substrate.

FIG. 5 is a simplified cross section of substrate with coated clear or transparent colored resin film containing particles of iron or other magnetically positionable spheres, particles or flakes with specialty additive of the invention included to orientate said spheres, particles or flakes within the wet-film and enabling reorientation of the said spheres, particles or flakes under electrical charged forces of induction from below the wet-film and the substrate.

FIG. 6 is a simplified cross section of substrate with coated clear or transparent colored resin film containing particles of iron or other magnetically oriented spheres, particles or flakes which are subject to orientation from induction (magnetic) with a specialty additive of the discovery included to maintain the orientation of the spheres, particles or flakes within the wet film.

### DETAILED DESCRIPTION OF THE PREFERRED EMBODIMENT

As noted, the formulation for the paint or coating herein described and disclosed, for use in spraying, silk screening, or other manner of application to a surface or substrate employs additives with the magnetically positionable particles or pigments, which allow for improved processing and manufacturing methods for imparting indicia or images upon coated substrates and utilizing controlled applied forces of induction upon the particles in the wet-film.

The conventional method dictated by conventional paint, is for a part having the substrate to be coated, to be placed directly upon an actual magnet and once so positioned, the substrate is then spray coated. The magnet(s) magnetic field communicated through the substrate and thus the inducted image is generated by reorientating particles in the wet-film above the magnet and substrate.. In the conventional method, dictated by current paint formulations, both the top and bottom side of the substrate needs to be relatively parallel to enable the induced field communicated through the substrate, to be uniform, and for the image to thus maintain crispness of definition and detailing.

However, a problem develops in that the inherent properties of molded plastics and their structure benefits usually dictate a non-linear exterior surface (depth of edges, portals, contours, curvatures) as well as interior supporting ribs, bosses, secondary mechanical features which are well known of the trade, thus making a uniform, flat top side or underside surfaces only applicable as a molded, extruded or cast sheet.

As noted, in a non-linear substrate construction, the magnet is then further distanced away from the top wet-film and the resultant magnetic field is either weak or nearly nonexistent. It is the experience of the inventor that in the conventional method dictated by conventionally employed paint, a distance between a magnet and the wet filmed substrate surface of less than 0.040″ or 1.0 mm needs to be uniformly maintained to allow any degree of image definition or clarity in the image formed by the reoriented particles. Once the distance exceeds 0.080″ or 2.0 mm, the formed image is completely diffused and at perhaps 0.160″ or 4.0 mm the image becomes entirely diffused.

Equally problematic using conventional paint employing repositionable particles, molded parts exhibit degrees of dimensional instability from the molding process and depending upon the size of the part may readily exhibit random and non-uniform warpage due to stresses from molding which in-turn increases Z-axis warpage in excess of 4.0 mm. With such variances, using conventionally employed paint having magnetically oriented particles, rendering an image in the wet-film on the substrate may be nearly impossible.

Still further, a piece-part forming the substrate may have many uniform flat underside areas, internal portals and edges yielding cornering and vertical wall dimensions easily well in excess of the limitations noted above, thus rendering the possibility of an image to be mute using conventionally formulated paint or coatings with magnetically oriented particles.

Where formerly the magnet or means for imparting induction, would be required to remain stationary and proximate to the substrate surface being coated, until the coating substantially dried, employing the formulation herein described and disclosed, the magnet may be removed and the wet-film of the coated surface allowed to dry over a time period. The resulting image or indicia will however remain substantially the same as if the magnet or other induction source remained adjacent to the coated surface for substantially the entire duration of drying. As can be ascertained by those skilled in the art, the improved formulation for the disclosed paint or coating, will greatly enhance the manufacturing of products by allowing for increased speed, efficiency and increased quality of indicia imparted to the coating during the coating process. No longer need the substrate being coated, remain stationary while drying and thereby inhibiting production. Using the disclosed formula for the paint or coating, high quality indicia and images may be imparted to the substrate of products which may be moved more quickly for drying.

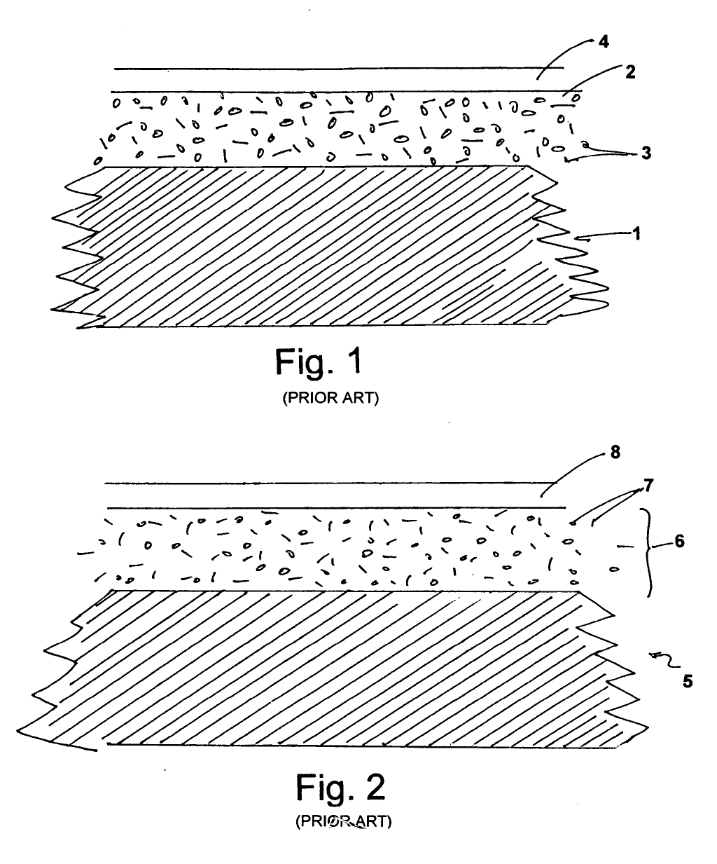

As can be seen in FIG. 1, which depicts prior art paint and coatings, such coatings are employed conventionally on surfaces 1, such as substrates of molded plastics, extruded and cast films or sheets, fabricated or machined metal, glass or ceramics. In the conventional process, coated clear or substantially transparent colored resin 2 in a wet-film is formed from a of variety of various acrylics, is used as a resinous vehicle to carry pigments and added metallic or mica flakes 3 dispensed within the film itself. Frequently, an optional clear or transparent top coat 4 of conventional acrylic, conventional 2K or UV urethane is employed. Such coatings are used widely and have no inductive image properties.

In FIG. 2, which is also conventional in the nature of prior and current art, the substrate surface 5 which may be formed of various substrates of molded plastics, extruded and cast films or sheets, fabricated or machined metal, glass or ceramics, is covered by the clear or transparent colored resin forming the wet film in the prior art. Added magnetically positionable particles 7 of iron, nickel or other oriented spheres, particles or flakes which are magnetically positionable by charged forces of induction are dispensed within the resin 6 film. This conventional coating is impaired by the inability of movement away from the magnetic source imparting the position to the particles 7 until the wet-film is substantially dry, and the inability to coat vertically disposed substrate surfaces 5 because of settling of the particulate in the resin 6 film during drying which would cause the particles 7 and other particulate to settle impairing or preventing the positioning of the particles 7 by a magnet or source of induction to form an image.

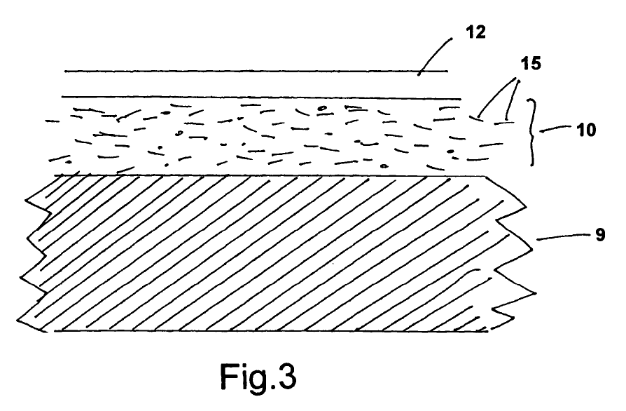

The formulation of the disclosed paint herein is shown in FIG. 3 which depicts the substrate surface 9 being covered or coated by a substantially clear or transparent colored resin forming a wet-film 10 layer, formed of one of a variety of various acrylics suitable to the purpose and noted herein. The magnetically positionable particles 15 of iron, nickel or other magnetically orientable spheres or particles, are positionable for angle in three dimensions providing spatial effects employing the electrical charged force of a magnet or induction communicating through the wet-film 10 during image impartation in the wet-film state. Through the employment of the additives herein disclosed, a means to maintain magnetically positionable particle orientation subsequent to removal of the magnetic field from a position proximate to the wet-film 10 layer is provided. This maintaining of particle 15 orientation in the wet-film 10 layer for a duration of time required to move and dry the wet-film 10 allows the substrate 9 to be moved more quickly than conventional paints as noted earlier thereby allowing clear sharp images and indicia on the substrates 9 or surfaces of products moving along a production line. As has been noted, the ability to move the substrate 9 during drying of the wet-film 10, and maintain the image formed in the still wet-film 10 is a major improvement allowing for mass volume production of high quality magnetically imaged surfaces heretofore unachievable. A clear coating 12 may be added over the wet-film 10 if desired after drying.

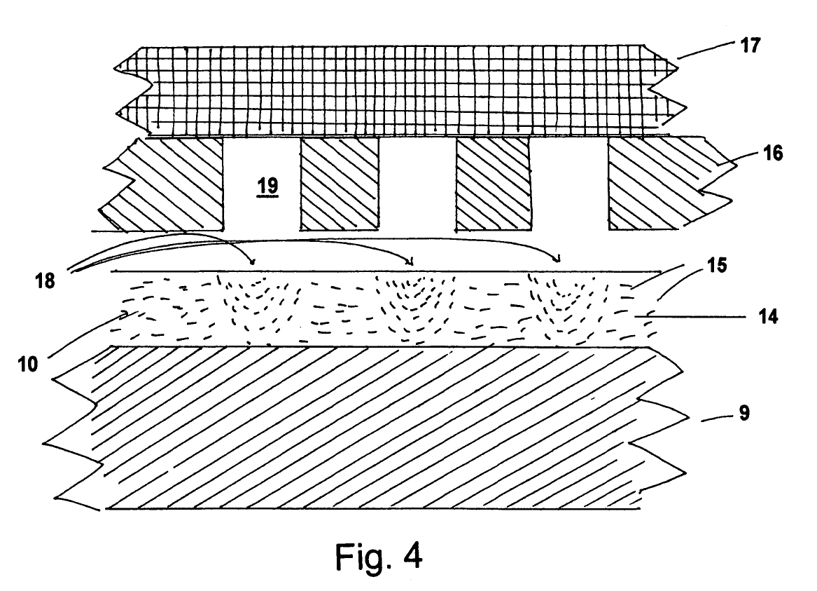

Employing the additives noted herein as shown in FIG. 4, the surface of substrate 9 being coated with the resin 14, is maintained in a formed wet filmed 10 state to allow migration or reorientation of positionable particles 15 of iron or nickel or other magnetically positionable particles 15 to form the image 18 when the particles are subjected to the magnetic field provided by the adjacent indicia imaging tool 16 formed of a magnet 17 and metallic planar sheet imaging tool 16 which reorients the particles 15 to form the indicia 18 in the wet-film 10 layer.

As noted the inventive formula for the paint herein, allows positioning of the magnet 17 above or below the wet-film 10 layer and substrate 9 and for irregular and varied substrate thickness which heretofore has been substantially unachievable. Employing the paint herein disclosed, the thickness restrictions of a substrate 9 or part noted above for imparting an image are overcome. Using the paint herein disclosed, the wet-filmed substrate or piece part need not be placed on-top of a magnet or magnetic element, thus the limitations are not related to overall thickness of the substrate. Inventor has imaged upon substrates as thin as 0.005″ and as thick as 6″. Further, since the positioning of the magnet below the substrate required by prior art is no longer necessary, and the thickness restrictions are overcome, the invention herein allows for imaging upon planar, convex, concave, or outline/silhouette on one or two sides, without any limitations of thickness. Adhesive backed films may also be imaged and applied to the substrate surface using the paint herein.

In one preferred manner of imparting images to the wet-film 10 layer that employment of the paint herein will now allow, the communication of the charged force of induction from the anisotropic and axial pole of the magnet 17 through the metallic sheet forming the induction imaging tool 16 interface and its recesses or apertures 19 imparts a particle 15 orientation in the wet-film 10 and thereby forms indicia from the imaging tool 16 and into the particles 15 in the wet-film 10. The resulting image is imparted by the orientation of the particles 15 along the lines of the field which is influenced by the imaging tool 16 thereby creating an image in the wet-film 10 formed of the resin 14 located proximate to the metallic planar sheet forming induction imaging tool 16 which is engaged to or adjacent to the magnet 12. As noted, using prior art formulations for such paint, an overhead positioning of the imaging tool 16 has not yielded images that were commercially viable.

The formulation for the coating herein described and disclosed, includes additives as a means to maintain the field induced orientation of the particles 15 in a wet-film 10 of paint once the induction imaging tool 16 and magnet 17 are removed, and preferably an additive means to maintain the resin employed as the carrier for the particles 15 in the wet-film 10, sufficiently wet to allow the reorientation of the particles 15 when subjected to the magnetic field through the induction imaging tool 16.

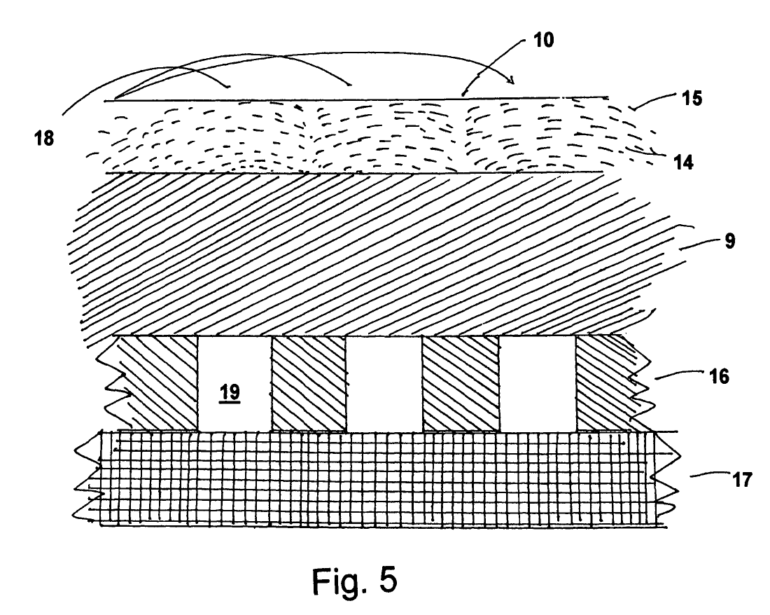

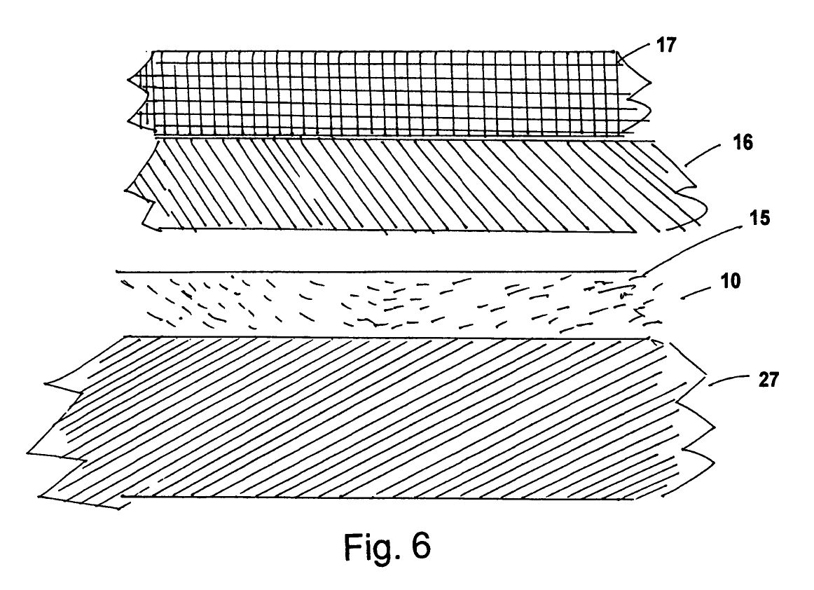

The employment of the additives and formulation herein thus allows for communication of the magnetic field from below the substrate 9 surface as shown in FIG. 5 in the conventional fashion with much improved results in the formed image as well as allowing the substrate 9 covered in a wet-film 10 layer to be removed before the wet-film 10 is fully dry. Or, in an especially preferred mode, the magnetic field may be communicated from above the surface 27 as shown in FIG. 6 since it may also be moved and the image formed concurrently stabilized to maintain it in a wet-film 10 layer. The formulation preferred employs a solvent based carrier including one or more of a combination of polymers or other resinous material with sufficient transparency and clarity on drying not to impair the image or indica formed by the particles 15 in the wet-film 10 layer when dried. One such base material or carrier is a Sherman Williams clear acrylic lacquer.

To that is added magnetically orientable particles 15 preferably in the form of flakes formed entirely or partially of one or a combination of iron or nickel or other particles or flakes pigments which may be magnetically influenced for position in the wet-film 10. Such particles 15 are added by weight to equal from 0.5 to 20 percent of the total weight of the mixture of the formulation depending upon the density of the image. One such especially preferred magnetically positionable particle 15 is STAPA TA Ferricon sometimes referred to as Ferricon 200 as manufactured by ECKART GmbH & Co KG. However, those skilled in the art will realize that other iron-based pigments and particles or such particles that are reactive to a magnetic field may be employed with the paint herein to yield the enhanced induction influenced image in the wet-film 10 and subsequently the dried layer provided by the formulation herein disclosed.

Means to maintain the orientation of the particles 15 positioned by the magnetic force in the wet-film 10, is currently best provided by the addition of a first additive in the form of a wax which when said wet-film 10 is dry, maintains a very clear or transparent nature so as not to impair the formed image. This final clarity in the dried paint is most important since the image formed by the oriented particles 15 would cloud or be impaired with an additive of improper clarity. The current preferred means for such stabilization or maintaining particle orientation in the wet-film 10 layer is best provided by inclusion of one or a combination of such wet-film stabilization additives including ethylene-vinyl-acetate copolymer (EVA) or ethylene acrylic acid (EAA) or ethylene with a mixture of xylene. The wax content of the carriers should equal approximately 50% resin solids by total weight.

Means to maintain particle orientation after removal of the magnetic field from adjacent to the wet-film 10 layer having oriented particles 15 may be further enhanced by inclusion of an additive means to prevent settling of the particles 15 and sag. This may be provided by inclusion of cellulose acetate butyrate (CAB) in combination with the first wax additive for this purpose noted above. The CAB offers increased protection against reorientation of the positioned particles 15 in the wet-film 10 and also against sag and settling of particles 15 repositioned by the magnetic 17 and imaging tool 16 on a vertically oriented substrate 13 which is sprayed or silkscreened or otherwise coated with the paint.

Additional additives to protect against sag and settling of the paint and particles 15 in a vertically oriented substrate 13 being coated with paint by spaying silkscreening or other means for application, may also be added along with the first means to maintain particle orientation, with preferred such additional additives being hydrophilic silica with polyhydroxycarboxylic acid or organic modified clays with bentone. Or, modified urea with n-methyl-pyrollidone may be included.

Particularly preferred also is additive means to maintain the applied wet-film 10 layer in a wet condition to allow reorientation of the magnetically positionable particles 15 before the coating thickens too much or dries. Currently the preferred mode of this additive to maintain the wet-film 10 in a wet condition has been found to be diacetone alcohol (DEA) in a ratio of between 0.5 to 5% by weight with a particularly favored ratio between 2-3 percent of the total weight of the coating mixture. The ratio is adjusted upward as the size of the image imparted to the wet-film 10 increases to allow the larger area to maintain a uniform wetness. Currently between 2-3 percent is a favored ratio with 3 percent being used with larger indica areas and 2 percent where smaller areas of uniform wetness is required.

Finally, it should be noted that if the coating is to be colored with effect or other metallic pigments it must maintain sufficient transparency to still allow for viewing of the image formed by the magnetically positionable particles 15.

While all of the fundamental characteristics and features of the improved disclosed and described paint or coating for a substrate which yields detailed images using magnetically positionable particles in a wet-film with reference to particular embodiments thereof, a latitude of modification, various changes and substitutions are intended in the foregoing disclosure and it will be apparent that in some instance, some features of the invention will be employed without a corresponding use of other features without departing from the scope of the invention as set forth. It should be understood that such substitutions, modifications, and variations may be made by those skilled in the art without departing from the spirit or scope of the invention. Consequently, all such modifications and variations are included within the scope of the invention as defined herein.

What is claimed is:

1. A paint for application in a layer on a substrate and adapted to form images in said layer using a magnetic field, comprising a mixture including:
a substantially clear resinous carrier;
magnetically orientable particles added to said carrier component;
additive means to maintain an orientation of said particles induced by said magnetic field in a communication through a wet-film of said clear resinous carrier applied to said substrate, for a duration of time subsequent to cessation of said communication magnetic for said wet-film to dry sufficiently to maintain said particles in said orientation permanently; and
said duration of time being proportional to a percentage of said additive means to a total weight of the mixture.

2. The paint of claim 1 wherein said additive means to maintain said orientation comprises a wax.

3. The paint of claim 2 wherein said additive means to maintain said orientation includes one or a combination of materials from a group consisting of ethylene-vinyl acetate copolymer (EVA), ethylene acrylic acid (EAA), and ethylene with a mixture of xylene.

4. The paint of claim 3 additionally comprising a second additive means to prevent settling of said particles in a wet-film applied to a vertically positioned said substrate.

5. The paint of claim 3 wherein said second additive means is cellulose acetate butyrate.

6. The paint of claim 1 wherein said magnetically positionable particles equal from 0.5 to 20 percent of the total weight of the mixture.

7. The paint of claim 2 wherein said magnetically positionable particles equal from 0.5 to 20 percent of the total weight of the mixture.

8. The paint of claim 3 wherein said magnetically positionable particles equal from 0.5 to 20 percent of the total weight of the mixture.

9. The paint of claim 4 wherein said magnetically positionable particles equal from 0.5 to 20 percent of the total weight of the mixture.

10. The paint of claim 5 wherein said magnetically positionable particles equal from 0.5 to 20 percent of the total weight of the mixture.

11. The paint of claim 2 wherein said wax comprises 50% resin solids by total weight.

12. The paint of claim 3 wherein said wax comprises 50% resin solids by total weight

13. The paint of claim 4 wherein said wax comprises 50% resin solids by total weight

14. The paint of claim 5 wherein said wax comprises 50% resin solids by total weight

15. The paint of claim 7 wherein said wax comprises 50% resin solids by total weight.

16. The paint of claim 8 wherein said wax comprises 50% resin solids by total weight.

17. The paint of claim 9 wherein said wax comprises 50% resin solids by total weight.

18. The paint of claim 10 wherein said wax comprises 50% resin solids by total weight.

19. The paint of claim 3 additionally comprising a third additive means to maintain said wet-film in a wet condition for a time period sufficient for said magnetic filed to induce said orientation of said particles, said time period being proportional to a ratio of said third additive means to said total weight of said mixture.

20. The paint of claim 19 wherein said third additive means is diacetone alcohol (DEA) and said ratio is between 0.5 to 5% by said total weight of said mixture.

21. The paint of claim 20 wherein said ratio is between 2 to 3% of said total weight of said mixture.

22. The paint of claim 4 additionally comprising a third additive means to maintain said wet-film in a wet condition for a time period sufficient for said magnetic filed to induce said orientation of said particles, said time period being proportional to a ratio of said third additive means to said total weight of said mixture.

23. The paint of claim 22 wherein said third additive means is diacetone alcohol (DEA) and said ratio is between 0.5 to 5% by said total weight of said mixture.

24. The paint of claim 23 wherein said ratio is between 2 to 3% of said total weight of said mixture.
